(19) United States
(12) Patent Application Publication
(10) Pub. No.: US 2014/0109981 A1
(43) Pub. Date: Apr. 24, 2014

(54) MANAGEMENT TECHNIQUE FOR HYDRAULIC LINE LEAKS

(71) Applicant: SCHLUMBERGER TECHNOLOGY CORPORATION, Sugar Land, TX (US)

(72) Inventors: Ives D. Loretz, Houston, TX (US); Erdinc Cosgun, Sugar Land, TX (US); Spyro Kotsonis, Missouri City, TX (US)

(73) Assignee: Schlumberger Technology Corporation, Sugar Land, TX (US)

(21) Appl. No.: 13/655,172

(22) Filed: Oct. 18, 2012

(51) Int. Cl. F16L 55/163

(52) U.S. Cl. 137/15.11; 138/98

(57) ABSTRACT

A self-seeking plug for deployment in a hydraulic line with a leak therein. The plug is configured for circulation through the line and to a resting location adjacently below or past the location of the leak in the line. As a result, the location of the leak may be identified, for example with reference to a tether running between the resting location and the site of deployment. Thus, line repair may more readily ensue. Additionally, and/or alternatively, sealing repair may ensue by way of sealing element(s) outfitted on the plug. Such may or may not be accompanied by an exposable bypass channel through the plug for sake of full hydraulic restoration of the line.

### BACKGROUND

Exploring, drilling and completing hydrocarbon wells are generally complicated, time consuming and ultimately very expensive endeavors. As a result, over the years increased attention has been paid to monitoring and maintaining the health of such wells. Significant premiums are placed on maximizing the total hydrocarbon recovery, recovery rate, and extending the overall life of the well as much as possible. Thus, logging applications for monitoring of well conditions play a significant role in the life of the well. Similarly, significant importance is placed on well intervention applications, such as clean-out techniques which may be utilized to remove debris from the well so as to ensure unobstructed hydrocarbon recovery.

In addition to interventional applications, the well is often outfitted with various hydraulic control lines between surface equipment and certain downhole features. In this manner, such features may be manipulated without the requirement of an interventional application. For example, downhole chemical injection or control over valves at downhole locations may be exercised without the time consuming or costly need for a dedicated intervention. Such hydraulic control lines are routinely used for opening and closing of safety, flow control and formation isolation valves, as well as for setting packers to achieve isolation in the well.

What is more, with advancements in well placement and intelligent completions technologies, it is becoming increasingly more common to multi-drop several downhole tools on one or more hydraulic control lines. For example, technological building blocks are readily available to run three or more flow control valves on shared hydraulic control lines to afford separate control of injected or produced fluids from multiple reservoir intervals. Therein, shared control lines offer the benefit of minimizing the number of control lines necessary for downhole control. This in turn alleviates restrictions that may be present from available feed through passages in packers, liner hangers, or other constrained areas.

Hydraulic control lines as described above are installed in conjunction with various other completions hardware. Indeed, such lines may be a part of a fairly sophisticated well architecture. For example, the well may have casing terminating at a production region that is governed by a formation isolation valve, with a production screen, shroud and other components therebelow. Further, a host of valves, packers, sleeves and other features for ongoing manipulation may be positioned uphole of the production region. Once more, the formation isolation valve along with the noted features and a host of others may be managed by way of hydraulic control lines running adjacent to, or even embedded within, the casing.

As with any other downhole components, hydraulic control lines may be subject to unintentional damage. For example, damage resulting in a leak in a line may occur during installation or during later downhole interventions or regular production or injection activities. Regardless, once a leak develops in a hydraulic control line, its functionality, and that of its associated downhole tools, is effectively lost. Also, leakage in the line may provide an unintended pathway for hazardous downhole production fluids to reach the oilfield surface in an uncontrolled manner.

Further complicating matters for leaking control lines is the fact that the ability to repair hydraulic lines is limited by the nature of downhole architecture as alluded to above. For example, at best, access to a hydraulic control line is likely limited to a narrow annulus between the casing and a production or other access tubing which runs the length of the well. Thus, the ability to reach and repair the line to an effective working condition is unlikely.

Once more, determining where a leak may be located in the line may not be achieved with any satisfactory degree of certainty. As a result, it may be a significant challenge to determine how the leak may have been caused. Thus, since the cause of the leak remains unknown, the liable party remains unknown. Perhaps even more concerning is the fact that without knowledge of the cause of the leak, operators are severely limited in their ability to properly plan any mitigation measures going forward.

In light of the various problems associated with a leak in a hydraulic control line, operators are likely to address the matter, at least as a matter of safety. For example, a cement plug may be advanced within the line in a manner sufficient to at least sealably block the emergence of any hazardous downhole fluids through the line as a result of the leak. Thus, personnel and equipment at the oilfield surface may be spared exposure to any significant hazards as a result of the leak.

Indeed, operators may undertake attempts to position a plug as far downhole as possible but above the likely location of the leak. In this manner, functionality of the line may be restored for all controlled valves and features above the cement plug. Unfortuntately, functionality for controlled valves and features below the cement plug may only be attained upon dedicated interventions directed at such features. For example, where the leak is located between a formation isolation valve and a flow control valve further uphole, the cement plug may be set above the leak in a manner restoring line control over the flow control valve with subsequent control of the formation isolation valve requiring a dedicated intervention. Once more, as noted, restoring complete functionality to the line may not be achieved in this manner. Rather, the line is rendered only partially restored for sake of controlling valves and actuatable features above the leak.

Of course, setting a plug in a manner described above is a blind exercise, which is why in most historical cases operators were forced to cement the entire length of control line to avoid any potential ambiguity about the location or effectiveness of the plug.

### SUMMARY

A plug for a leaking hydraulic line or chemical injection line is disclosed. The plug includes a main body that is configured for fluid driven advancement through an inner channel defined by the line to a location adjacent the leak. The body is outfitted with a substantially sealable biasing outer surface for guided interfacing thereof relative an inner wall of the line during the advancement. Further, the plug may be part of a larger management system for the leak which further includes a tether line coupled to the plug and running to an oilfield surface with the line.

### BRIEF DESCRIPTION OF THE DRAWINGS

FIG. 1 is an enlarged view of an embodiment of a hydraulic line plug advancing toward a leak in a hydraulic line.

FIG. 2 is an overview depiction of a well at an oilfield accommodating the hydraulic line of FIG. 1 for control of different actuatable well features.

FIG. 3A is a side view of alternate embodiment of the plug of FIG. 1 advancing toward the leak in the line thereof.

FIG. 3B is a side view of the plug of FIG. 3A upon reaching a target location adjacent the leak in the line.

FIG. 3C is a side view of the plug of FIG. 3B upon expansion of a seal element above the leak in the line.

FIG. 3D is a side view of the plug of FIG. 3C upon opening of a channel through the interior of the plug to allow for hydraulic bypass.

FIG. 4A is another embodiment of the plug of FIG. 1 with an anchor element incorporated thereinto.

FIG. 4B is yet another embodiment of the plug of FIG. 1 configured to drive a curable fluid to the location of the leak.

FIG. 5 is a flow-chart summarizing an embodiment of employing a hydraulic line plug for management of a leak in a hydraulic line.

### DETAILED DESCRIPTION

Embodiments are described with reference to certain configurations of completions hardware that make use of hydraulic line control over various downhole actuatable features. In particular, formation isolation valves and isolation packers are depicted. However, other actuatable valves and features may operate via hydraulic control lines as detailed herein. Regardless, once a leak emerges in such a line, embodiments herein include a plug and techniques which may be utilized for identification of the leak location as well as potential avenues for streamlined repair of the leaking line.

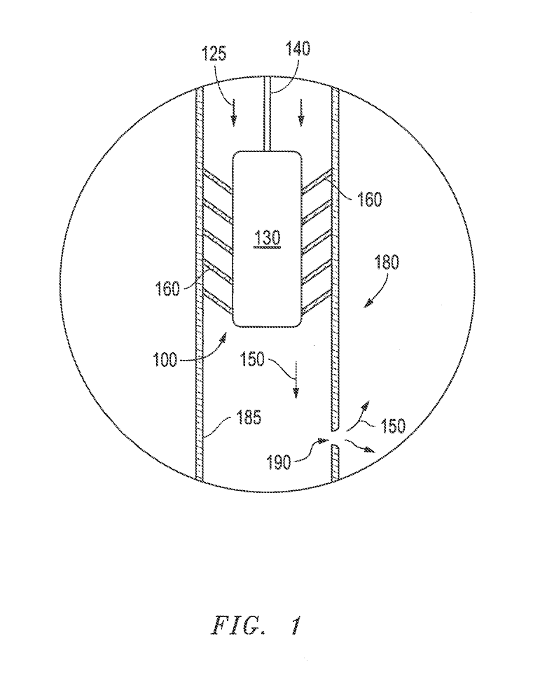

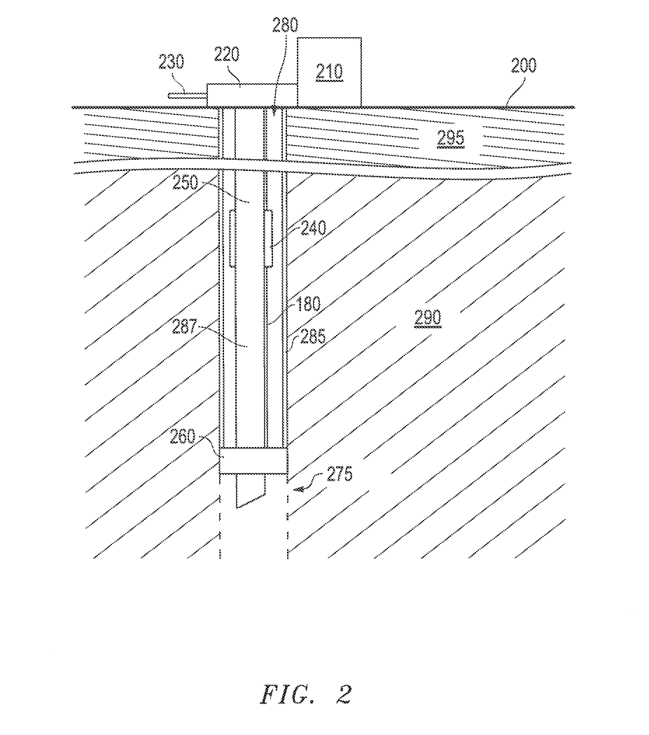

Referring now to FIG. 1, an enlarged view of an embodiment of a hydraulic line plug 100 is depicted advancing toward a leak 190 within a hydraulic line 180. More specifically, the plug 100 may be inserted into the line 180 at a surface location of an oilfield 200 and fluidly pumped through the line 180 as shown (see FIG. 2). By the same token, in the embodiment shown, the main body 130 of the plug 100 is coupled to a tether 140 maintaining a structural connection to the surface. Thus, as the plug 100 advances through the line 180, its distance may be tracked. Ultimately, as described below, this may allow an operator to establish the location of the leak 190 by way of reference to the tether 140 as examined at surface.

Continuing with reference to FIG. 1, the plug 100 is advanced downhole in the direction depicted in a fluidly circulating manner. More specifically, once inserted into the line 180, a pumping fluid 125 may be used to drive the plug 100 downhole. At the same time, leaking fluid 150 below the plug 100 may also continue downhole with some exiting the line 180 through the breach or location of the leak 190 as shown. As this fluid circulation is taking place, fins 160 which circumferentially emerge from the body 130 are used to serve as a wiper-type sealing interface between the plug 100 and an inner surface 185 of the line 180. The fins 160 provide a substantially sealable biasing outer surface in stably guiding the plug 100 downhole. Indeed, as shown, the uppermost fin 160 serves as the direct interface with the pumping fluid 125 such that stable and sealable downhole guiding interface is immediately provided. Additionally, fins may be added to improve seal redundancy or debris wiping functionally.

In the depiction of FIG. 1, the plug 100 is shown just before reaching the location of the leak 190. However, once the uppermost fin 160 reaches a location just below the leak 190, the pumping fluid 125 will now be able to breach the location of the leak 190. As a result, the plug 100 will come to rest and cease to continue in the downhole direction. Thus, the plug 100 may be thought of as ‘self-seeking’ in relation to finding or reaching the location of the leak 190. From an operator's perspective at the surface of an oilfield 200, this also means that after up to thousands of feet of unspooling, the tether 140 will noticeably cease its spooling out into the hydraulic line 180. Thus, the operator may be provided with an approximate location of the leak 190. That is, the depth reflected by the amount of tether 140 that has been drawn from surface to the plug 100 at rest will be indicative of the leak 190 and plug 100 location.

With the location of the leak 190 now identified, subsequent action may be taken that is targeted at the leak 190 in an intelligent and selective manner. For example, the tether 140 may be broken off from the plug 100 and removed, with the plug 100 left in place as a downhole marker. Alternatively, the plug 100 may be withdrawn from the line 180 by retraction of the tether 140 from surface without decoupling from the plug 100. In either case, subsequent cement or other plugging of the leak 190 may be undertaken in an intelligent manner as indicated. Further, in an embodiment where the plug 100 is removed via the tether 140, vent channels may be provided through the main body 130 such that bypass of pumping fluid 125 may occur in conjunction with, and to help promote, the uphole withdrawal of the plug 100. As described in further detail below, such channels would be smaller in diameter or opening area than the leak 190 and/or exposed only upon the noted withdrawal so as to ensure downhole pumping of the plug 100 to below the location of the leak 190 is not compromised.

Continuing with reference to FIG. 1, a conventional hydraulic control line 180 as depicted, may typically be between ⅛ and ½ of an inch in diameter, perhaps with an inner diameter of about 0.15 inches. Accordingly, to match the inner diameter of such a line 180, the main body 130 of the plug 100 may be about 0.1 inches in diameter with fins 160 extending over the remaining 0.05 inches or so. Indeed, the fins 160 may be a bit greater in size, but of an elastic, semi-flexible character to ensure the sealable guidance as detailed above.

Referring now to FIG. 2, an overview depiction of a well 280 at an oilfield 200 is shown as alluded to above. The completed well 280 accommodates a host of hardware, including the hydraulic line 180 of FIG. 1. More specifically, the line 180 is located in the relatively tight space of an annulus 287 between the casing 285 defining the well 280 and production tubing 250 described below. Regardless, control over different actuatable well features, such as one or multiple packers 240, flow control valves, or formation isolation valve 260 may be exercised remotely from surface via the control line 180. For example, an operator may make use of a control unit 210 disposed at the oilfield 200 adjacent the well head 220 to direct a variety of downhole operations including those triggered by the line 180.

As indicated in earlier descriptions, the self-seeking plugs and associated variations may also be applied to chemical injection lines. Such lines are routinely used to provide single or multi-point delivery of chemicals to inhibit corrosion, formation of hydrates, scale, etc. If unintended leaks develop in chemical injection lines, the consequences can be just as costly as indicated in the case of hydraulic control lines.

As indicated, the well 280 is defined by casing 285 as it traverses a formation 290 leading to a production region 275 below the noted formation isolation valve 260. By way of the hydraulic line 180, the operator may direct opening of the formation isolation valve 260. Thus, production through tubing 250 may take place via slotted liner, screen or other appropriate hardware defining the well 280 at the region 275. Ultimately, such production of hydrocarbons from the formation 290 may reach the surface and be routed through a production line 230 for collection.

In the embodiment shown, subsequent production from other locations may also take place, perhaps partially aided by use of the control line 180. For example, later operations may include isolating a zone of the well 280 by actuating the packer 240 and perforating the casing 285 to form a new production region. Indeed, the packer 240 may be employed such that a separate formation layer 295 and production region are isolated relative the well 280 for multi-zonal hydrocarbon recovery. Thus, from the outset, recovery options may be tailored in a zonal fashion.

Of course, remotely exercising control over such packer 240 or valve 260 features is achieved to the extent that the line 180 is kept in a leak free condition. For example, consider a circumstance where a leak 190 as depicted in FIG. 1 emerges at a location between the packer 240 and the flow control valve 260. At the outset, control over both features would be lost. However, surface equipment similar to that employed in threading fiber optics through conventional coiled tubing may be utilized to advance a plug 100 and tether 140 through the line 180 to identify the leak location (see FIG. 1). This may be followed by remedial cement plugging as also detailed regarding FIG. 1 hereinabove. As such, remote control over the packer 240 may be restored in a reliable manner without the pre-requisite of multiple blind interventional attempts just to locate the leak 190. Once more, in other embodiments detailed hereinbelow, remote functionality may also be restored to features below the leak 190, such as the formation isolation valve 260. That is, in such embodiments the plug application alone may serve to completely restore functionality of the entire hydraulic control line 180.

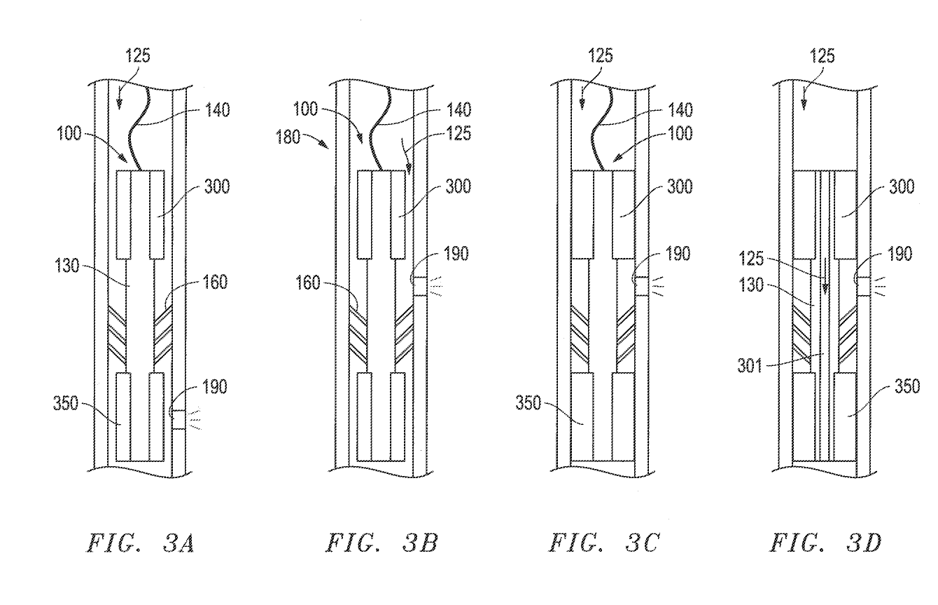

Referring now to FIGS. 3A-3D, side views of an alternate embodiment of the plug 100 are depicted for application within the hydraulic control line 180. More specifically, the self-seeking nature of the plug 100 embodiment of FIG. 1 is now equipped with added capacity in the form of a seal element 300 and bypass channel 301. Thus, as with the embodiment of FIG. 1, the plug 100 may approach and come to a resting location adjacent the leak 190 as depicted in FIGS. 3A and 3B. However, it may now also provide sealing within the line 180 and above the leak 190 as shown in FIG. 3C and even subsequently allow for controlled bypass 301 relative the leak 190 thereafter (see FIG. 3D).

As alluded to above, FIG. 3A depicts an alternate embodiment of the plug 100 of FIG. 1 advancing toward a leak 190 in the self-seeking fashion detailed herein. Specifically, pumped fluid 125 acts upon the fins 160 to drive the plug 100 downhole, so long as the uppermost fin 160 is above the leak 190. However, once the fins 160 reach a location below the leak 190 as shown in FIG. 3B, the plug 100 may come to rest. Again, this is due to the fact that such pumped fluids 125 may now have a pathway out of the line 180 through the leak 190. Thus, such fluid 125 may no longer be directed at the fins 160 with force sufficient to continue driving the plug 100 downhole.

Continuing with added reference to FIG. 3C, the plug 100 is equipped with the above noted seal element 300 distanced away from and above the location of the fins 160. Indeed, this distance is sufficient to ensure that once the plug 100 comes to rest with the fins 160 below the leak 190, the element 300 is above the leak 190. Stated another way, the leak 190 is straddled by the fins 160 below and the element 300 above.

The described seal element 300 may be of a conventional swellable elastomer of a type frequently used in swell packers and other swellable downhole elements often employed in the oilfield industry. Once more, an operator at surface may observe the detection of the leak 190 via the ceasing of the tether 140 to unwind into the line 180. At this time, as with other conventional swellables, constituents or characteristics of the pumped fluid 125 may be tailored in a fashion so as to help promote the swell. Regardless, depending on a variety of factors, full swell of the element 300 may take between minutes and days.

Continuing with reference to FIG. 3C, the line 180 is now of restored functionality above the plug 100. However, in the embodiment shown, the plug 100 is also outfitted with a secondary swell element 350 below the fins 160. Notably, since this element 350 is below the fins 160, it is also below the leak 190 once the plug 100 has come to rest as described hereinabove. Thus, upon swelling, the plug 100 provides sealing both above and below the location of the leak 190. Therefore, with added reference to FIG. 3D, a bypass channel 301 may be provided through the plug 100 in a manner that restores hydraulic functionality to the line 180. That is, the leak 190 is fully isolated from any fluid 125 which traverses the channel 301 for line control.

With specific reference to FIG. 3D, the tether 140 is shown removed from the plug 100 once full swelling of the elements 300, 350 has been achieved. In one embodiment, removal of the tether 140, uncorks, sets or otherwise triggers exposure of the bypass channel 301 through conventional means. Of course, rupture disk and other conventional techniques may also be employed to expose the channel 301 once the leak 190 has been isolated. Additionally, in one embodiment setting of an anchoring mechanism may also take place in conjunction with breaking away of the tether 140. Thus, flow through the bypass channel 301 need not be reduced or mitigated in order to ensure stable retention of the plug 100 in place as depicted. Atmospheric chambers, electrical pulses through the tether 140 and other conventional techniques as detailed below may also be utilized in setting downhole anchors and other tools of the plug 100.

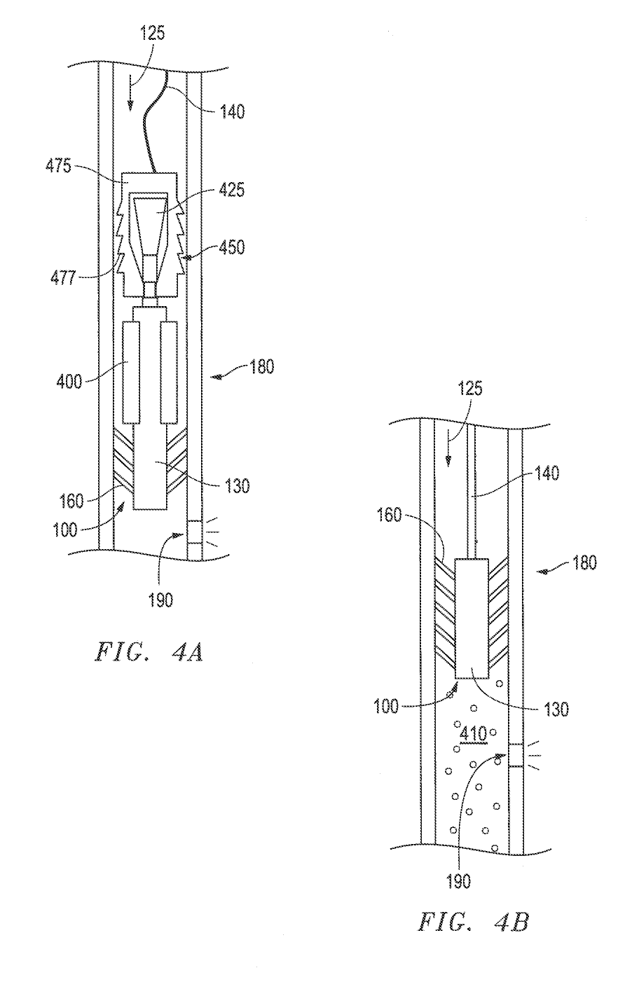

Referring now to FIG. 4A, another embodiment of the plug 100 is shown. In this case, both anchor 450 and swell 400 elements are incorporated into the plug 100. Once more, the swell element 400 is positioned in an overlapping or no more than a negligible distance uphole of the fins 160. Thus, once the fins 160 come to rest below the leak 190, the swelling of the element 400 will occur thereover. That is, rather than straddle the leak 190 with separate elements 300, 350, a single elongated element 400 of sufficient vertical dimensions may be utilized to cover over and isolate the leak 190 (e.g. see FIG. 3A).

Continuing with reference to FIG. 4A, setting of the anchor element 450 may be achieved by way of a pull upward on the tether 140 from surface. Thus, teeth 477 of an expansive member 475 may be forced into biting engagement with an inner surface of the control line 180 as the member 475 is wedged outward over an inner deflector 425. In an embodiment where a bypass channel is provided in conjunction with setting of the anchor element 450, restoration of full functionality of the control line 180 may be achieved with the plug 100 of FIG. 4A.

Referring now to FIG. 4B, yet another embodiment of a leak management technique is depicted which utilizes a plug 100 as detailed herein. More specifically, the plug 100 may be of a more refined configuration similar to that depicted in FIG. 1. However, in this embodiment, the plug 100 is utilized after locating and identifying the leak 190. Indeed, with any of the other embodiments of FIG. 3A-3D or 4A which may involve remedial repair to the line 180, such repair may optionally take place after identification of the location of the leak 190. However, in the specific embodiment of FIG. 4B, such identification takes place, followed by re-insertion of a plug 100 configured to drive an epoxy, cement, or other curable seal fluid 410 to the location of the leak 190. For example, note the tether 140 being maintained in a taut fashion as the pumping fluid 125 forces the plug 100 downhole. The plug 100 of FIG. 4B is not being utilized in a self-seeking manner relative the leak 190. Rather, the tether 140 of FIG. 4B is specifically being used as a measurement guide in more precise positioning of the plug 100 above the leak 190 after the location thereof is already known.

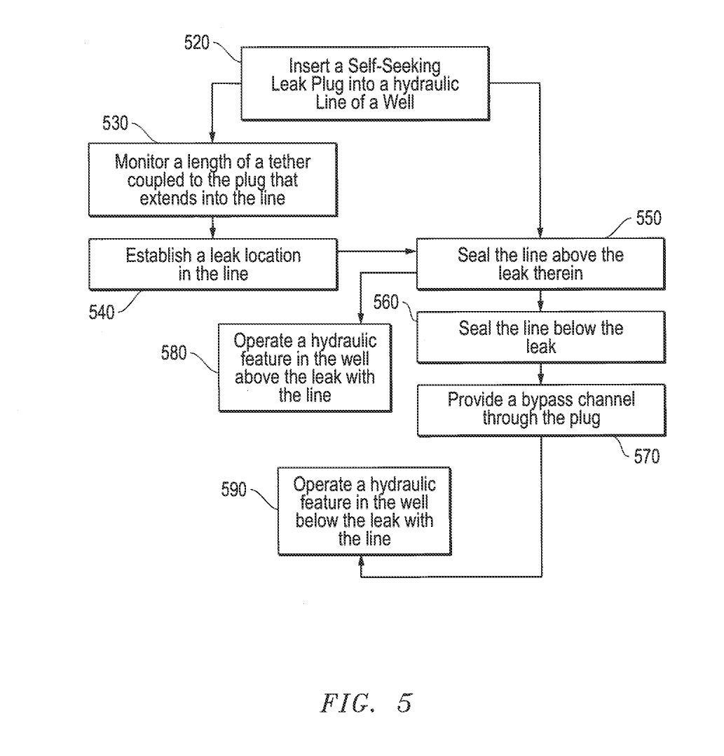

Referring now to FIG. 5, a flow-chart is shown summarizing an embodiment of employing a hydraulic line plug for management of a leak in a hydraulic line. The plug is self-seeking relative locating a leak in the line as detailed hereinabove and indicated at 520. Accordingly, a tether coupled to the plug may be monitored from surface as noted at 530. Thus, as indicated at 540, the location of the leak in the line may be established. With such information now available, the line may be sealed above the leak as indicated at 550, for example through a follow-on application as noted hereinabove with reference to FIG. 4B or even FIGS. 3A-3D and/or 4A. Of course, due to the self-seeking nature of the plug, it may be configured to achieve the seal directly without requirement of subsequent plug re-insertion (see FIGS. 3A-3D and 4A).

Continuing with reference to FIG. 5, with the line sealed above the leak, it may be used to operate hydraulic features in the well that are also above the leak and coupled to the line (see 580). Additionally, depending on the particular plug configuration, sealing below the leak may also be provided and a bypass channel exposed through the plug as noted at 560 and 580. Where such capacity is provided, the entire leak may be isolated in a manner that hydraulic features below the leak are also operable as indicated at 590. In one embodiment, this type of sealing and bypass are achieved through a single elongated seal over the entire leak, as opposed to separate seals at either side thereof (see FIG. 4A). Regardless, complete functionality may be restored to the line in this manner.

Embodiments described hereinabove include hydraulic line plugs and techniques for managing leaks in hydraulic lines. This may include providing the capacity to locate and/or control leaks. Thus, the amount of time and expense lost to multiple attempts at directing a plug to a most appropriate leak site may be minimized Once more, as opposed to partial functionality, a line may be restored to full functionality without the requirement of a dedicated intervention, in a manner heretofore unseen.

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. For example, self-seeking plugs as detailed herein may be utilized for delivery of add-on tools apart from seal or anchoring elements. Such may include pressure, temperature and other measurement or diagnostic type devices delivered in the manner detailed. Additionally, the term “leak” as used herein may refer to an unintentional fluid path as noted hereinabove or even an intentional fluid path such as a designed breach of a hydraulic line. Regardless, the foregoing description should not be read as pertaining only to the precise structures described and shown in the accompanying drawings, but rather should be read as consistent with and as support for the following claims, which are to have their fullest and fairest scope.

We claim:

1. A plug for a hydraulic line having a leak, the plug comprising:
a main body for fluid driven advancement through an inner channel defined by the line to a resting location adjacent the leak; and
a substantially sealable biasing outer surface of said body for guided interfacing of said body relative an inner wall of the line during the advancement.

2. The plug of claim 1 wherein said outer surface comprises at least one circumferential fin about said body.

3. The plug of claim 1 wherein the line is one of a hydraulic control line and a chemical injection line for use in a well at an oilfield, the plug further comprising a tether coupled thereto, said tether running from a surface of the oilfield adjacent the well to reflect a depth of the resting location.

4. The plug of claim 3 wherein said body comprises at least one vent channel therethrough to promote withdrawal thereof from the line via said tether.

5. The plug of claim 1 further comprising a seal element about said body for hydraulically sealing the line with the plug at the resting location.

6. The plug of claim 5 wherein said seal element is a first seal element distanced above said biasing outer surface, the plug further comprising:
an exposable fluid bypass channel through said body; and
a second seal element about said body and below said biasing outer surface.

7. The plug of claim 5 wherein said seal element is an elongated seal element extending from said biasing outer surface to a distanced location so as to exceed vertical dimensions of the leak, the plug further comprising an exposable fluid bypass channel through said body.

8. The plug of claim 1 further comprising an anchor element extending from said body for stably securing the plug in the line at the resting location.

9. A method of managing a hydraulic control line with a leak therein, the method comprising:
inserting a self-seeking leak plug into the control line from an oilfield surface location adjacent a well accommodating the line; and
circulating the plug through the line to a resting location adjacent the leak.

10. The method of claim 9 wherein said monitoring comprises:
spooling a tether coupled to the plug from the surface location; and
establishing a location of the leak in the line by reading the tether at the surface location after ceasing of said spooling due to the plug reaching the resting location.

11. The method of claim 9 further comprising sealing the line at a location therein at least as high as the leak location.

12. The method of claim 11 wherein said sealing comprises one of expanding a seal element of the plug, cement plugging, and pumping a curable seal fluid to the leak location.

13. The method of claim 11 further comprising actuating a hydraulic well feature coupled to the line at a location above the leak.

14. The method of claim 9 wherein said circulating comprises:
pumping a fluid through the line from the surface location; and
guiding the plug in the line with a substantially sealable biasing outer surface of the plug for interfacing an inner surface of the line.

15. The method of claim 9 further comprising removing the plug from the line by withdrawing the tether therefrom.

16. The method of claim 15 further comprising exposing vent channels through the body during said removing to promote the withdrawing.

17. A method of repairing a leak in a hydraulic line, the method comprising:
inserting a self-seeking leak plug into the line;
circulating the plug through the line to a resting location adjacent the leak; and
sealing the line at a location above the leak.

18. The method of claim 17 wherein said sealing comprises expanding a first seal element of the plug, said method further comprising:
expanding a second seal element of the plug for sealing the line at a location below the leak for isolation thereof; and
exposing a bypass channel through a body of the plug to restore hydraulic flow to the line.

19. The method of claim 18 further comprising triggering said exposing by manipulating a tether coupled to the plug from a remote location relative thereto.

20. The method of claim 18 further comprising actuating a hydraulically controlled feature coupled to the line at one of a location above the leak and a location below the leak.
